(19) United States
(12) Patent Application Publication
(10) Pub. No.: US 2011/0071868 A1
(43) Pub. Date: Mar. 24, 2011

(54) SYSTEMS AND METHODS FOR TAILORING THE DELIVERY OF HEALTHCARE COMMUNICATIONS TO PATIENTS

(75) Inventors: Kimberly Parker, Franklin, TN (US); Don Eddleman, Brentwood, TN (US)

(73) Assignee: Healthways World Headquarters, Franklin, TN (US)

(21) Appl. No.: 12/614,212

(22) Filed: Nov. 6, 2009

Related U.S. Application Data
(60) Provisional application No. 61/244,838, filed on Sep. 22, 2009.

(51) Int. Cl. G06Q 10/00; G06Q 50/00

(52) U.S. Cl. 705/7

(57) ABSTRACT

A computer implemented method may be used for tailoring communications to a plurality of patients. The clinical priority of each communication, the likelihood of a patient responding to the communication if received at a particular time, and the available resources for performing the communications may be analyzed in order to prioritize and schedule the plurality of patient communications.

### RELATED APPLICATIONS

This application claims the benefit of U.S. Patent Application No. 61/244,838 filed on Sep. 22, 2009, which is hereby incorporated herein by reference in its entirety.

### BACKGROUND OF THE INVENTION

1. Field of the Invention

In a preferred embodiment, this application relates to systems and methods for communicating health or wellness information to clients, and more particularly to scheduling communications related to health and wellness information.

2. Description of the Related Art

Managing a population of patients to improve health and wellness may involve interacting with patients in that population through a series of conversations where a clinician, coach, or medical specialist guides a patient towards better decisions for the patient's overall health. In some cases these conversations are delivered via a telephone dialer system that prioritizes calls by maximizing the number of attempts to reach each patient. Successful connection rates for telephonic intervention using this type of system are often less than 10%, meaning that healthcare, and wellness services providers must do a significant amount of rework in order to deliver the promised service. Thus, it is desirable to have a method for predicting the best time and method to contact a patient in order to maximize the number of successful communications between a medical specialist and a patient.

### SUMMARY OF THE INVENTION

In one embodiment, a computerized method of scheduling a plurality of patient communications comprises determining the available resources for communicating a plurality of patient communications, determining the clinical priority of each patient communication, determining the relative likelihood of receiving a response to each patient communication based on the time of the patient communication, organizing the plurality of patient communications into time slots based on the likelihood of receiving a response, the clinical priority of each patient communication, and the available resources, and outputting a schedule for performing patient communications based on the organized patient communications. The time of the communication may be a time of day, a day of the week, a particular date, or a week of a month. Determining the available resources for communicating a plurality of patient communications may comprise analyzing the skill set of each individual responsible for performing the communications. Determining the clinical priority of each patient communication may comprise categorizing the patient communication, assigning a priority based on the category of the communication, and adjusting the priority of the communication based on the length of time the communication has been scheduled but not completed. The method of scheduling a plurality of patient communications may further comprise determining the time and content of a future patient communication based on the response received from the patient communication. The method of scheduling a plurality of patient communications may further comprise determining a relative priority of the patient communications within a time slot and ordering the patient communications within the time slot based on the relative priority. Determining the relative likelihood of receiving a response to each patient communication my comprise analyzing a correlation between patient demographics and the likelihood for a patient to respond to a patient communication performed in a particular time slot. Patient demographics may be age and gender. Determining the relative likelihood of receiving a response to each patient communication may comprise analyzing communication preference information received from the patient. Determining the relative likelihood of receiving a response to each patient communication may comprise analyzing the patient's health status. A predictive model may be used to determine the relative likelihood of receiving a response to each patient communication. Organizing the patient communications may be performed by a computing device. The method of scheduling a plurality of patient communications may further comprise contacting a patient on the basis of the schedule. In one embodiment, the patient is contacted using an apparatus selected from the group consisting of a computer, a portable computing device, or a telephone.

In another embodiment, a computerized method of scheduling a plurality of patient communications comprises receiving information indicative of the available resources for communicating a plurality of patient communications, receiving information indicative of the clinical priority of each patient communication, receiving information indicative of the relative likelihood of receiving a response to each patient communication based on the time of the patient communication, organizing the plurality of patient communications into time slots based on the likelihood of receiving a response, the clinical priority of each patient communication, and the available resources, and outputting a schedule for performing patient communications based on the organized patient communications. The time of the communication may be a time of day, a day of the week, a particular date, or a week of a month. The method of scheduling a plurality of patient communications may further comprise determining the time and content of a future patient communication based on the response received from the patient communication. The method of scheduling a plurality of patient communications may also further comprise determining a relative priority of the patient communications within a time slot and ordering the patient communications within the time slot based on the relative priority. Organizing the patient communications may be performed by a computing device. In one embodiment, the method of scheduling a plurality of patient communications further comprises contacting a patient on the basis of the schedule. The patient may be contacted using an apparatus selected from the group consisting of a computer, a portable computing device and a telephone.

In another embodiment, a system for scheduling a plurality of patient communications, the system comprises a memory storing information associated with a plurality of patients and a processor to perform determining the available resources for communicating a plurality of patient communications, determining the clinical priority of each patient communication, determining the relative likelihood of receiving a response to each patient communication based on the time of the patient communication, organizing the plurality of patient communications into time slots based on the likelihood of receiving a response, the clinical priority of each patient communication, and the available resources, and outputting a schedule for performing patient communications based on the organized patient communications. The time of the communication may be a time of day, a day of the week, a particular date, or a week of a month. Determining the available resources for communicating a plurality of patient communications may comprise analyzing the skill set of each individual responsible for performing the communications. Determining the clinical priority of each patient communication may comprise categorizing the patient communication, assigning a priority based on the category of the communication, and adjusting the priority of the communication based on the length of time the communication has been scheduled but not completed. The processor may further perform determining the time and content of a future patient communication based on the response received from the patient communication. The processor may further perform determining a relative priority of the patient communications within a time slot and ordering the patient communications within the time slot based on the relative priority. Determining the relative likelihood of receiving a response to each patient communication may comprise analyzing a correlation between patient demographics and the likelihood for a patient to respond to a patient communication performed in a particular time slot. Patient demographics may comprise age and gender. Determining the relative likelihood of receiving a response to each patient communication may comprise analyzing communication preference information received from the patient. Determining the relative likelihood of receiving a response to each patient communication may comprise analyzing the patient's health status. A predictive model may be used to determine the relative likelihood of receiving a response to each patient communication.

In another embodiment, a computerized system for scheduling a plurality of patient communications, the system comprises a memory storing information indicative of the available resources for communicating a plurality of patient communications, information indicative of the clinical priority of each patient communication, and information indicative of the relative likelihood of receiving a response to each patient communication based on the time of the patient communication and a processor to perform organizing the plurality of patient communications into time slots based on the likelihood of receiving a response, the clinical priority of each patient communication, and the available resources and outputting a schedule for performing patient communications based on the organized patient communications. The time of the communication may be a time of day, a day of the week, a particular date, or a week of a month. The processor may further perform determining the time and content of a future patient communication based on the response received from the patient communication. The processor may further perform determining a relative priority of the patient communications within a time slot and ordering the patient communications within the time slot based on the relative priority.

### BRIEF DESCRIPTION OF THE DRAWINGS

FIG. 1 is a block diagram illustrating one embodiment of a communication tailoring system.

FIG. 2 is a flow chart illustrating one embodiment of a process for tailoring communications, such as using the system of FIG. 1.

### DETAILED DESCRIPTION OF CERTAIN EMBODIMENTS

The system, method, and devices of embodiments of the invention each have several aspects, no single one of which is solely responsible for its desirable attributes. Without limiting the scope of this invention as expressed by the claims which follow, its more prominent features will now be discussed briefly. After considering this discussion, and particularly after reading this section, one will understand how the features of this invention provide advantages that include providing more efficient methods and systems for communicating with patients.

The following detailed description of certain embodiments presents various descriptions of specific embodiments of the invention. However, the invention can be embodied in a multitude of different ways as defined and covered by the claims. For example, while this discussion describes the use of the invention in the context of patient communications, it will be appreciated that, in some embodiments, the inventions can be used in other contexts where it is desirable to contact an individual. In this description, reference is made to the drawings wherein like parts are designated with like numerals throughout.

The terminology used in the description presented herein is not intended to be interpreted in any limited or restrictive manner, simply because it is being utilized in conjunction with a detailed description of certain specific embodiments of the invention. Furthermore, embodiments of the invention may include several novel features, no single one of which is solely responsible for its desirable attributes or which is essential to practicing the inventions herein described.

The system is comprised of various modules, tools, and applications as discussed in detail below. As can be appreciated by one of ordinary skill in the art, each of the modules may comprise various sub-routines, procedures, definitional statements and macros. In some embodiments, each of the modules are typically separately compiled and linked into a single executable program. Therefore, the following description of each of the modules is used for convenience to describe the functionality of embodiments of the system. Thus, the processes that are undergone by each of the modules may be arbitrarily redistributed to one of the other modules, combined together in a single module, or made available in, for example, a shareable dynamic link library.

The system modules, tools, and applications may be written in any programming language. For example, in some embodiments, the applications may be written in C, C++, C#, BASIC, Visual Basic, Pascal, Ada, Java, HTML, XML, or FORTRAN, and executed on an operating system. In some embodiments, the operating system may be Windows, Macintosh, UNIX, Linux, VxWorks, or another variant of the foregoing operating system. C, C++, BASIC, Visual Basic, Pascal, Ada, Java, HTML, XML and FORTRAN are industry standard programming languages for which many commercial compilers can be used to create executable code.

Healthcare providers, insurance companies, and other healthcare entities must often contact patients, for example to deliver or request information, discuss healthcare options, or schedule appointments. A communication attempt made without an actual connection, such as an unanswered phone call, can result in the patient not receiving critical healthcare information. If a patient cannot be reached in the initial attempt, the provider must use additional resources to deliver the message and thus ensure that the service is delivered as promised.

In one embodiment, a communication tailoring systems permits a service provider to tailor the delivery of a communication or encounter to a patient in a way that maximizes the probability of actual communication with the patient. Maximizing the number of successful communications may decrease the resources and cost necessary to contact some patients. In one embodiment, the communication tailoring system maximizes successful communications for the most important communications rather than increasing the number of successful low priority communications. In one embodiment, in order to determine the best way to allocate communication resources, the communication tailoring system may weigh the available system resources, the likelihood of a communication with a patient being successful at a particular time through a particular method, and the clinical priority of the particular communication.

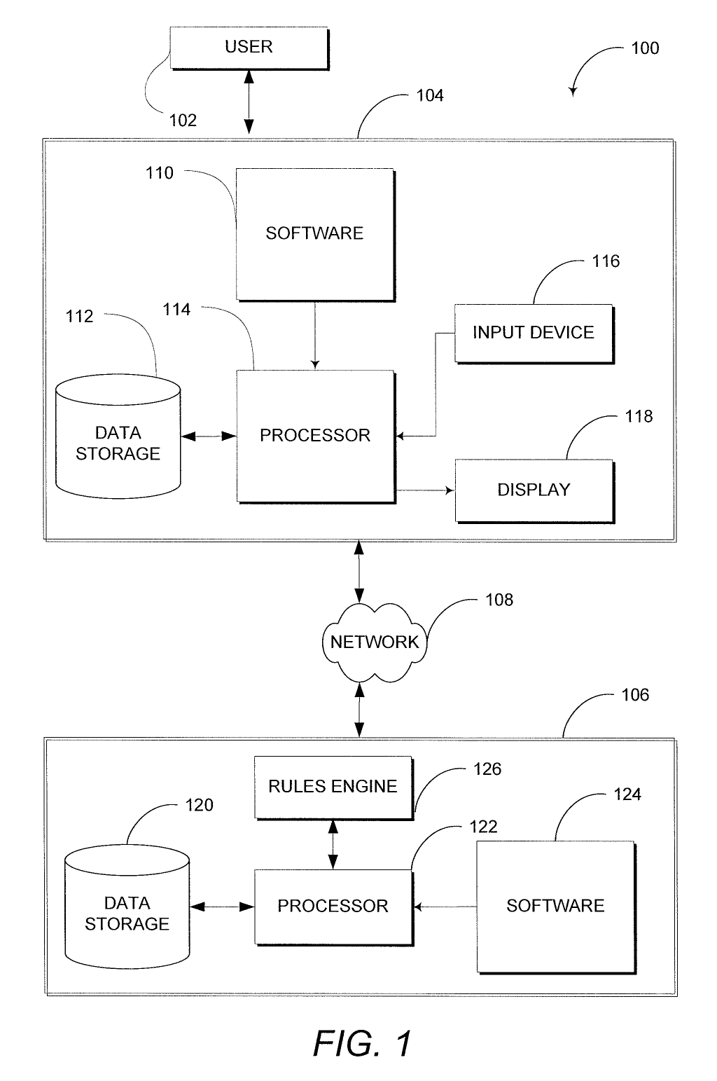

FIG. 1 is a block diagram illustrating one embodiment of a communication tailoring system 100. In this embodiment, a mobile or fixed computing device 104 is operated by a user 102. In some embodiments, the computing device 104 can be a handheld computing device or other portable computing device such as a Palm, Pocket personal computer (PC), Linux based handheld, PDA, smartphone, Tablet PC, or PC having a display. Alternatively, the computing device 104 may be a personal computer having a built in or separate display. The computing device 104 in certain embodiments operates in a stand-alone (independent) manner. In other embodiments, the computing device 104 is in communication with one or more computing devices 106, such as a server, via a network 108. The computing devices 106 include one or processors 122, a data storage 120, a rules engine 126, and system software 124 executed by the processor(s) 122.

In certain embodiments, the data storage 120 stores one or more databases used by the system, and stores patient medical records. The processor(s) 122 are in communication with the database(s) via a database interface, such as structured query language (SQL) or open database connectivity (ODBC). In certain embodiments, the data storage 120 is not included in computing device 106, but is in data communication with the computing device 106 via the database interface.

The rules engine 126 establishes rules for tailoring communications with patients. The rules engine 126 may embodied in hardware, software, or both of these. In one embodiment, the rules executed by the rules engine 126 are related to relationships found in a study performed by Healthways, Inc. To improve real connectivity and to enhance the ability to achieve outcomes on the population, a study was performed to evaluate attributes that affect successful delivery of communications. The results of these studies yielded operational factors based on trial results that increase operational efficiency by maintaining consistently high productivity for internal providers while also maximizing for true connectivity instead of number of attempts. The processor 122 may leverage these results which may be accomplished by the addition of clinical and financial factors to the decision-making regarding communication delivery. The study was conducted using different types of communications, using regression analysis and a fit test against the regression analysis. For each hour state of a day, the rules engine 126 weights variables, such as age, gender, number of unsuccessful communications times, clinical relevance, and other factors. It will be appreciated that, in embodiments in which the claimed invention is used to contact individuals who are not patients, factors relevant to the demographics and criticality of contact of the desired group of individuals may be considered.

The healthcare system 100 may include a network 108, which may represent a local area network (LAN), a wide area network (WAN), the Internet, or another connection service. The connection from the computing device 104 to the network 108 can be a wireless or a satellite connection or a wired or direct connection. In certain embodiments, the server(s) are part of a web site, such as on an intranet or the Internet.

The computing device 104 includes a processor 114, an integral or separate display 118, and one or more input devices 116. The processor 114 is in data communication with a data storage 112 for storing one or more databases having data such as medical data used by the system. In certain embodiments, the data storage 112 stores data such as patient medical records. System software 110 is executed by the processor 114. The system software 110 includes an application graphical user interface (GUI). The application GUI can include a database interface to the data storage 112 of the computing device. In certain embodiments, the software is loaded from the data storage 112. In embodiments where the computing device 104 communicates with a web site, the processor utilizes browser software in place of or in addition to the software 110. The network 108 may connect to a user computer 104, for example, by use of a modem or by use of a network interface card. A user 102 at computer 104 may utilize a browser to remotely access the programs using a keyboard and/or pointing device and a visual display, such as a monitor. Alternatively, the browser is not utilized when the programs are executed in a local mode on computer 104. A video camera may be optionally connected to the computer 104 to provide visual input.

In one embodiment, the methods discussed herein are executed on the processor 114. In another embodiment, the methods are executed on the processor 122 with output sent via the network 108 to the computing device 104. In one embodiment, the programs and databases reside on a group of servers that are interconnected by a LAN and a gateway to a network. Alternatively, the programs and databases reside on a single server that utilizes network interface hardware and software. The servers store the information described herein.

Various other devices may be used to communicate with the computing device 106. If the servers are equipped with voice recognition or DTMF hardware, the user can communicate with the program by use of a telephone. Other connection devices for communicating with the computing device 106 include a portable personal computer with a modem or wireless connection interface, a wireless device such as a mobile telephone or a smart phone, a cable interface device connected to a visual display, or a satellite dish connected to a satellite receiver and a television. Other ways of allowing communication between the user 102 and the servers 106 are envisioned.

As used herein, actions such as the process described herein below, performed by the processor 122 may be performed by any suitable hardware or software, including the processor 114, the processor 122, and/or the rules engine 126.

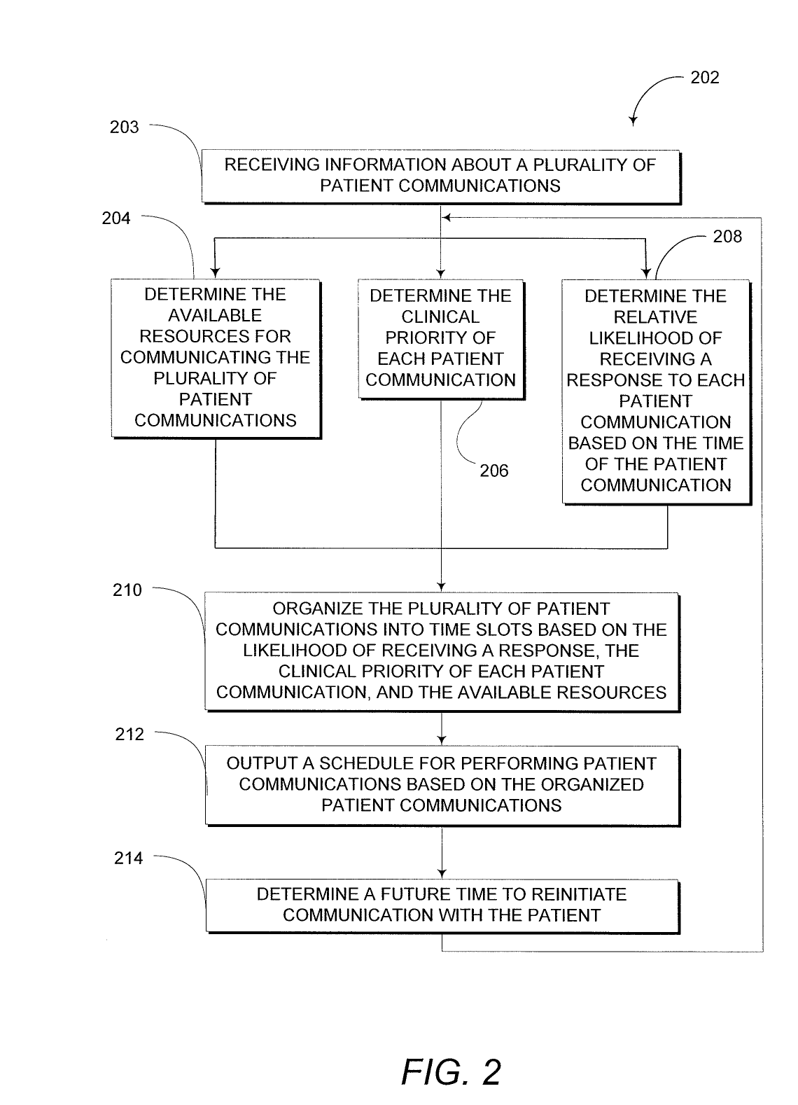

FIG. 2 is a flow chart illustrating a process 202 for tailoring communications. In one embodiment, the process 202 is executed on a computing device. Beginning at a state 203, the process 202 receives information about a plurality of patient communications. The information may include information about necessary patient communications. In one embodiment, the process 202 determines which patient communications are necessary rather than receiving the information from another source. In one embodiment, the process 202 analyzes the patient's contract to determine which patient communications should be made. For example, a healthcare plan may authorize certain types of communications or a certain frequency of communications. Other criteria for determining whether a patient communication should be made include, for example, whether the patient has requested not to be contacted, whether new data is available (such as claims, lab information, or healthcare usage information), whether a reminder for a scheduled appointment is necessary, whether an inbound communication was received from a patient, and whether a healthcare provider has requested that a patient communication be made.

After the state 203, the process 202 may advance to one of a state 204, 206, or 208. The process 202 may perform the states 204, 206, and 208 in any order, and in one embodiment, the process 202 may also skip one or more of the states 204, 206, and 208. In one embodiment, the process 202 performs the states 204, 206, and 208 simultaneously.

Continuing to a state 204, the process 202 determines the available resources for communicating the plurality of patient communications. The process 202 may evaluate multiple factors when determining the available resources. For example, the process 202 may consider the number of service providers, the skill sets of the service providers, average time per communication, types of available resources, and the service provider staff idle time. The process 202 may further analyze the volume of the necessary patient communications and the objectives for the system. The process 202 may also consider the resources for multiple types of communications, such as telephone, web, email, and mail communications. In one embodiment, the process 202 executes one or more predictive models in order to determine the available resources.

In one embodiment, the process 202 also determines the available resources based on a particular delivery approach devoted to each communication. The delivery approaches may include, for example, a team, one to one, dedicated, group, limited team, and community approaches. A team approach may involve a team of providers (e.g., clinicians or coaches) where the team of providers interacts with an individual patient where communications are automatically distributed to one of the members of the particular team of providers based on heuristics designed to maximize outreach and balancing probability of success with priority of the communication. This is desirable because individuals are often not expecting to be contacted and interacting with different providers for each interaction.

In one embodiment, a one to one delivery approach occurs when a primary provider initiates interaction with an Individual through scheduled appointments. Individuals expect to be contacted at a scheduled time and with the same provider for each interaction.

In another embodiment, a dedicated delivery approach involves a primary provider interacting with a patient through the automatic distribution of encounters to that provider. Individuals are often not expecting to be contacted, but do expect to interact with the same provider for each interaction.

Other embodiments include a group delivery approach where a group of patients are serviced by one provider, a limited team delivery approach where a single provider manages the distribution to a set of other providers for an individual patient in a given population, and a community delivery approach where individuals interact with other patients often under the of a healthcare management system and channels provided by a healthcare management system, such as moderated forums.

After the state 203, the process 202 may also continue to a state 206, in which the process 202 determines the clinical priority of each patient communication. In one embodiment, the process 202 stores the clinical priority in the database 120 shown in FIG. 1. In another embodiment, the rules engine 126 determines the clinical priority based on multiple factors. The factors may be, for example, the health status of the patient, type of communication, clinical relevance of communication to be delivered, aging of communications never attempted, and number of failed attempts for the communication. In one embodiment, the rules engine 126 assigns a ranking to each communication that is indicative of the relative priority of the communication.

In one embodiment, the communication has a priority based on the type of communication. The type of communications may be, for example, base, immediate, remote monitoring, and specialty communications. Base communications may represent typical communications delivered by an internal provider such as care or follow up communications. Immediate communications may represent any communications that must be delivered in a short time frame, such as on the particular day. Remote monitoring communications may represent communications that are specialized, such as communications from resources that can manage alerts from equipment managed in a patient's home. Specialty communications may be communications that have been separated out for treatment independent of operational factors listed previously.

In one embodiment, the process 202 places each communication in one of the four categories, or buckets, mentioned above and prioritizes it within the category. This priority forms the base clinical priority. The process 202 then adjusts the base clinical priority based on how long the communication has been waiting for delivery, either because it was never attempted or because there was not a successful communication resulting from an attempt.

Table 1 below shows one embodiment of an example chart of communication types, communication names along with the communication category and priority based on the type of communication. It will be appreciated that other communication types may also be utilized. The process 202 could further adjust the priority based on conditions relevant to the particular communication.

TABLE 1

| Communication | | | |
|---|---|---|---|
| Type | Communication Name | Priority | Category |
| Care | Condition Management | 70 | Base |
| Care | High Risk Management | 70 | Base |
| Care | Final - Disease Management | 65 | Base |
| | Lite | | |
| Care | Final - Lifestyle Management | 65 | Base |
| Care | Disease Management Lite | 60 | Base |
| Care | Lifestyle Management | 60 | Base |
| Discharge- | Disease Management Lite | 60 | Base |
| Conclusion | | | |
| Discharge- | Lifestyle Management | 60 | Base |
| Conclusion | | | |
| Engagement | Disease Management Lite | 60 | Base |
| | Engagement | | |
| Engagement | Initial-Patient | 60 | Base |
| Engagement | Lifestyle Management | 60 | Base |
| Engagement | NewTo | 60 | Base |
| Engagement | ReEngagement | 60 | Base |
| HealthUpdate | Depression Screening Results | 60 | Base |
| Followup | Behavior Quit Date | 50 | Base |
| Followup | Behavior Start Date | 50 | Base |
| Followup | Engagement | 50 | Base |
| Followup | Engagement - Pregnancy | 45 | Base |
| Followup | AppointmentVisit | 40 | Base |
| Followup | Remove Engagement | 40 | Base |
| Followup | Engagement - Weight | 40 | Base |
| | Complications | | |
| Engagement | Research Confirmation | 30 | Base |
| HealthUpdate | Provider | 30 | Base |
| Reminder | Appointment Visit | 30 | Base |
| Reminder | Flu-Pneumonia Vaccination | 30 | Base |
| Reminder | Standard Of Care | 30 | Base |
| Referral | Case Management | 25 | Base |
| Referral | Coaching | 25 | Base |
| Referral | Dietary | 25 | Base |
| Referral | External Provider | 25 | Base |
| Referral | Mental or Behavioral Health | 25 | Base |
| Referral | Nursing | 25 | Base |
| Referral | Oncology | 25 | Base |
| Referral | Pharmacy | 25 | Base |
| Referral | Provider Services Manager | 25 | Base |
| Referral | Psychiatry | 25 | Base |
| Referral | Respiratory Therapy | 25 | Base |
| Referral | Social Work | 25 | Base |
| Information | Benefits | 20 | Base |
| Information | Complaint-Patient | 20 | Base |
| Information | Complaint-Provider | 20 | Base |
| Information | Miscellaneous | 20 | Base |
| CriticalRiskEvent | Initial - General | 90 | Immediate |
| CriticalRiskEvent | Initial - Medication Possession | 90 | Immediate |
| | Ratio | | |
| CriticalRiskEvent | Initial - Pregnancy | 90 | Immediate |
| Followup | Discharge | 90 | Immediate |
| Followup | Discharge Re-Engagement | 90 | Immediate |
| Any | Inbound - Any | 85 | Immediate |
| CriticalRiskEvent | Followup - General | 80 | Immediate |
| CriticalRiskEvent | Followup - Medication | 80 | Immediate |
| | Possession Ratio | | |
| CriticalRiskEvent | Followup - Pregnancy | 80 | Immediate |
| Alert | Heart Failure Remote Monitoring | 80 | Remote |
| | | | Monitoring |
| Engagement | Heart Failure Remote Monitoring- | 70 | Remote |
| | Patient | | Monitoring |
| Followup | Heart Failure Remote | 65 | Remote |
| | Monitoring-Patient Engagement | | Monitoring |
| HealthUpdate | Heart Failure Remote Monitoring - | 65 | Remote |
| | Provider | | Monitoring |
| Discharge- | Heart Failure Remote Monitoring - | 60 | Remote |
| Conclusion | Delnstall | | Monitoring |
| Engagement | Heart Failure Remote Monitoring - Provider | 60 | Remote |
| | | | Monitoring |
| Followup | Heart Failure Remote Monitoring - | 50 | Remote |
| | Patient Troubleshooting | | Monitoring |
| Followup | Heart Failure Remote Monitoring - Vendor | 45 | Remote |
| | | | Monitoring |
| One-Time | Used for Speciality Campaigns - | 50 | Speciality |
| | names to be standardized | | |
| Referral | Home Pulmonary Education | | |

In one embodiment, the process 202 receives information about the clinical priority of each communication rather than itself performing the calculations. In one embodiment, a predictive model is used to determine the clinical priority of each communication.

After the state 203, the process 202 may also move to a state 208 to determine the relative likelihood of receiving a response to each patient communication based on the time and method of the communication. The time may be for example, a time of day, a day of the week, a particular date, or a particular week of a month. The method may be, for example, email, mail, voice mail, or telephone conversation. The process 202 may execute a predictive model that estimates the likelihood of a person responding to a communication from the service provider based on factors such as the patient's gender, location, age, preference data collected from the patient, and clinical picture. In one embodiment, whether the patient is an employee of the service provider is also a factor. Any suitable factors may be used. The rules engine 126, shown in FIG. 1, may use the rules determined from a study, such as the Healthways study mentioned above, in order to predict the probability of a successful communication delivered by a particular method at a particular time. In one embodiment, the determination as to whether a communication will be successful may be refined as additional information is gained from the patient. In one embodiment, the process 202 also analyzes a patient's response to previous communications in order to predict whether a future communication is likely to be successful.

In one embodiment, the process 202 determines the best time to contact a patient by assessing whether the recipient for that communication has a preference to be called during a specific block of time and the probability of success at any hour of the day. In certain embodiments, the process 202 determines the probability of success for any hour by the formula e^{x}/1+e^{x} where x is equal to regression values determined by multiple factors indicative of the likelihood of a successful communication. The factors may include, for example, the patient's gender, age, and other characteristics, the day of week, the number of delivery sessions previously attempted, occupation, importance of faith, and historical successful attempts. Any suitable factors may be used.

The process 202 may perform the steps illustrated in the states 204, 206, and 208 in any order. In one embodiment, the process 202 does not perform the steps in each of the states 204, 206, and 208. Instead, the process 202 may receive information indicative of the clinical priority, likelihood of success, and available resources.

At the completion of one or more states 204, 206, and 208, process 202 proceeds to a state 210 to organize the plurality of patient communications into time slots based on one or more of the likelihood of receiving a response, the clinical priority of each patient communication, and available resources. The process 202 may determine the earliest time that a communication should be scheduled and optionally, a date for which the communication should be cancelled if not delivered.

The process 202 may partition communications into timeslots based on the determined probability of success for delivering the communication to the patient for each hour of the day, the available resources, and the clinical priority of the communication. In some embodiments, the process 202 may order the communications within each timeslot based on the highest probability of success such that the first communication attempted in each time slot is the one that is most likely to result in actual communication. The process 202 may also prioritize the communications based on their clinical priority. In one embodiment, if the patient has provided a time preference, timeslots that correspond to the time preference are ranked first in order of probability of success followed by any other non-preferred hours in order of probability of success.

After completion of the state 210, the process 202 advances a state 212 and outputs a schedule for performing the patient communications based on the organized patient communications. The service provider may initiate communications based on the schedule.

Moving to a state 214, the process 202 determines a future time to reinitiate communication with the patient. In one embodiment, any communications not performed during the scheduled time slot are moved to the next time slot and reprioritized. This may occur because more communications are scheduled than can be completed in the time slot. In one embodiment, any remaining unperformed communications at the end of a day are scheduled for the next day. In one embodiment, the process 202 determines a reason for a failed communication and schedules a follow-up communication based on the reason for the failed communication. In one embodiment, a follow up communication is automatically scheduled for a particular time in the future, for example, for communications that should be delivered at regular intervals. In one embodiment, the follow up communications determined by the process 202 may be overridden by a clinician.

In one embodiment, the communication tailoring system determines if the previous communication was successful in order to determine whether a follow up communication is necessary. For example, in some cases a voice message may be considered a successful communication depending on the type of communication. Table 2 below shows types of communications and whether the particular communication type is considered successful if a voice message is left, but there is no communication with the patient.

TABLE 2

| | Consider Communication |
|---|---|
| Communication | Successful If Leave a |
| Type | Message |
| Engagement | No |
| Care | No |
| Critical Risk Event | No |
| FollowUp | No |
| DischargeConclusion | No |
| HealthUpdate | Yes |
| Information | Yes |
| Alert | No |
| OneTime | No |

In one embodiment, the process 202 redials a patient when a call is aborted or the patient hangs up. In one embodiment, the redialing is done within 15 minutes of the ended phone call. In other embodiments, other times are used. In one embodiment, the process 202 attempts to call the same patient up to three times in one day, but other frequencies are contemplated in other embodiments. In one embodiment, the process 202 redials a patient based on a time that the patient requests that he or she be called back.

In one embodiment, if the process 202 determines that a follow up communication is necessary, the follow up communication is also scheduled. To do this, the process 202 repeats itself and begins to perform at least one of 204, 206, and 208.

In one embodiment, the process 202 dynamically alters the workflow. For example, changes could include reassigned workflow based on a new clinical situation, new patient preferences, or a change in the provider's employees. The rules engine 126 can also be updated so that the relative rankings results are altered based on the same data. The process 202 may adjust the rules engine 126 based on changes in resources, spikes in certain types of communications, or addition of work. This allows for “real-time” re-evaluation of priority of attempts, and, therefore, improvement in the number of successful communications. The process 202 may update the preferences for communications as a patient's preferences or clinical situation changes.

Certain embodiments of the system and method as described herein may be part of a product such as Embrace™, soon to be available from Healthways, Inc. In one embodiment, the process 202 may be used to prioritize and schedule other types of communications that are not patient healthcare communications.

Healthways conducted a study to determine the effectiveness of some of the systems and methods used by the communication tailoring methods described above. The study found that the successful communication rate was 22.8% using the communication tailoring methods versus a 9.8% successful communication rate using traditional communication prioritization methods.

Those of skill in the art will recognize that the various illustrative logical states, modules, circuits, and algorithm steps described in connection with the embodiments disclosed herein may be implemented as electronic hardware, computer software, or combinations of both. To clearly illustrate this interchangeability of hardware and software, various illustrative components, states, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical states, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

While the above detailed description has shown, described, and pointed out novel features of the invention as applied to various embodiments, it will be understood that various omissions, substitutions, and changes in the form and details of the device or process illustrated may be made by those skilled in the art without departing from the intent of the invention. As will be recognized, the present invention may be embodied within a form that does not provide all of the features and benefits set forth herein, as some features may be used or practiced separately from others. The scope of the invention is indicated by the appended claims rather than by the foregoing description. All changes which come within the meaning and range of equivalency of the claims are to be embraced within their scope.

What is claimed is:

1. A computerized method of scheduling a plurality of patient communications, the method comprising:
determining the available resources for communicating a plurality of patient communications;
determining the clinical priority of each patient communication;
determining the relative likelihood of receiving a response to each patient communication based on the time of the patient communication;
organizing the plurality of patient communications into time slots based on the likelihood of receiving a response, the clinical priority of each patient communication, and the available resources; and
outputting a schedule for performing patient communications based on the organized patient communications.

2. The method of claim 1, wherein the time of the communication is a time of day, a day of the week, a particular date, or a week of a month.

3. The method of claim 1, wherein determining the available resources for communicating a plurality of patient communications comprises analyzing the skill set of each individual responsible for performing the communications.

4. The method of claim 1, wherein determining the clinical priority of each patient communication comprises:
categorizing the patient communication;
assigning a priority based on the category of the communication; and
adjusting the priority of the communication based on the length of time the communication has been scheduled but not completed.

5. The method of claim 1, further comprising determining the time and content of a future patient communication based on the response received from the patient communication.

6. The method of claim 1, further comprising:
determining a relative priority of the patient communications within a time slot; and
ordering the patient communications within the time slot based on the relative priority.

7. The method of claim 1, wherein determining the relative likelihood of receiving a response to each patient communication comprises analyzing a correlation between patient demographics and the likelihood for a patient to respond to a patient communication performed in a particular time slot.

8. The method of claim 7, wherein patient demographics comprise age and gender.

9. The method of claim 1, wherein determining the relative likelihood of receiving a response to each patient communication comprises analyzing communication preference information received from the patient.

10. The method of claim 1, wherein determining the relative likelihood of receiving a response to each patient communication comprises analyzing the patient's health status.

11. The method of claim 1, wherein a predictive model is used to determine the relative likelihood of receiving a response to each patient communication.

12. The method of claim 1, wherein organizing the patient communications is performed by a computing device.

13. The method of claim 1, further comprising contacting a patient on the basis of the schedule.

14. The method of claim 13, wherein the patient is contacted using an apparatus selected from the group consisting of a computer, a portable computing device and a telephone.

15. A computerized method of scheduling a plurality of patient communications, the method comprising:
receiving information indicative of the available resources for communicating a plurality of patient communications;
receiving information indicative of the clinical priority of each patient communication;
receiving information indicative of the relative likelihood of receiving a response to each patient communication based on the time of the patient communication;
organizing the plurality of patient communications into time slots based on the likelihood of receiving a response, the clinical priority of each patient communication, and the available resources; and
outputting a schedule for performing patient communications based on the organized patient communications.

16. The method of claim 15, wherein the time of the communication is a time of day, a day of the week, a particular date, or a week of a month.

17. The method of claim 15, further comprising determining the time and content of a future patient communication based on the response received from the patient communication.

18. The method of claim 15, further comprising:
determining a relative priority of the patient communications within a time slot; and
ordering the patient communications within the time slot based on the relative priority.

19. The method of claim 15, wherein organizing the patient communications is performed by a computing device.

20. The method of claim 15, further comprising contacting a patient on the basis of the schedule.

21. The method of claim 20, wherein the patient is contacted using an apparatus selected from the group consisting of a computer, a portable computing device and a telephone.

22. A system for scheduling a plurality of patient communications, the system comprising:
a memory storing information associated with a plurality of patients; and
a processor to perform:
determining the available resources for communicating a plurality of patient communications;
determining the clinical priority of each patient communication;
determining the relative likelihood of receiving a response to each patient communication based on the time of the patient communication;
organizing the plurality of patient communications into time slots based on the likelihood of receiving a response, the clinical priority of each patient communication, and the available resources; and
outputting a schedule for performing patient communications based on the organized patient communications.

23. The system of claim 22, wherein the time of the communication is a time of day, a day of the week, a particular date, or a week of a month.

24. The system of claim 22, wherein determining the available resources for communicating a plurality of patient communications comprises analyzing the skill set of each individual responsible for performing the communications.

25. The system of claim 22, wherein determining the clinical priority of each patient communication comprises:
categorizing the patient communication;
assigning a priority based on the category of the communication; and
adjusting the priority of the communication based on the length of time the communication has been scheduled but not completed.

26. The system of claim 22, wherein the processor further performs determining the time and content of a future patient communication based on the response received from the patient communication.

27. The system of claim 22, wherein the processor further performs:
determining a relative priority of the patient communications within a time slot; and
ordering the patient communications within the time slot based on the relative priority.

28. The system of claim 22, wherein determining the relative likelihood of receiving a response to each patient communication comprises analyzing a correlation between patient demographics and the likelihood for a patient to respond to a patient communication performed in a particular time slot.

29. The system of claim 28, wherein patient demographics comprise age and gender.

30. The system of claim 22, wherein determining the relative likelihood of receiving a response to each patient communication comprises analyzing communication preference information received from the patient.

31. The system of claim 22, wherein determining the relative likelihood of receiving a response to each patient communication comprises analyzing the patient's health status.

32. The system of claim 22, wherein a predictive model is used to determine the relative likelihood of receiving a response to each patient communication.

33. A computerized system for scheduling a plurality of patient communications, the system comprising:
a memory storing:
information indicative of the available resources for communicating a plurality of patient communications;
information indicative of the clinical priority of each patient communication; and
information indicative of the relative likelihood of receiving a response to each patient communication based on the time of the patient communication; and
a processor to perform:
organizing the plurality of patient communications into time slots based on the likelihood of receiving a response, the clinical priority of each patient communication, and the available resources; and
outputting a schedule for performing patient communications based on the organized patient communications.

34. The system of claim 33, wherein the time of the communication is a time of day, a day of the week, a particular date, or a week of a month.

35. The system of claim 33, wherein the processor further performs determining the time and content of a future patient communication based on the response received from the patient communication.

36. The system of claim 33, wherein the processor further performs:
determining a relative priority of the patient communications within a time slot; and
ordering the patient communications within the time slot based on the relative priority.
